(19) United States
(12) Patent Application Publication
(10) Pub. No.: US 2015/0079987 A1
(43) Pub. Date: Mar. 19, 2015

(54) TONE DETECTION SCHEDULING

(71) Applicant: QUALCOMM Incorporated, San Diego, CA (US)

(72) Inventors: Ming YANG, San Diego, CA (US); Tom CHIN, San Diego, CA (US); Qingxin CHEN, San Diego, CA (US); Guangming SHI, San Diego, CA (US)

(73) Assignee: QUALCOMM Incorporated, San Diego, CA (US)

(21) Appl. No.: 14/026,831

(22) Filed: Sep. 13, 2013

(51) Int. Cl. H04W 36/00

(52) U.S. Cl. CPC H04W 36/0061
USPC 455/436; 455/560

(57) ABSTRACT

A user equipment (UE) uses idle time slots for system acquisition for IRAT measurement. To speed up the IRAT measurement, the UE starts system acquisition for a for first Global System for Mobile Communications (GSM) cell. The UE suspends the system acquisition of the first GSM cell when the first GSM cell signal strength falls below a signal strength of another GSM cell in a neighbor list. The UE then stores information acquired during the system acquisition of the first GSM cell, prior to the suspension. The UE starts a system acquisition for a second GSM cell after the suspension. The UE then resumes the system acquisition of the first GSM cell using the stored information after the second cell is acquired or the acquisition process aborts.

### BACKGROUND

1. Field

Aspects of the present disclosure relate generally to wireless communication systems, and more particularly, to frequency correction channel (FCCH) tone detection scheduling.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes starting a system acquisition for a first Global System for Mobile Communications (GSM) cell. The method further includes suspending the system acquisition of the first GSM cell when a condition occurs. The method also includes storing information acquired prior to suspending. The method also includes starting a system acquisition for a second GSM cell. The method further includes resuming the system acquisition of the first GSM cell using the stored information.

According to another aspect of the present disclosure, an apparatus for wireless communication includes means for means for starting a system acquisition for a first Global System for Mobile Communications (GSM) cell. The apparatus may also include means for suspending the system acquisition of the first GSM cell when a condition occurs. The apparatus may also include means for storing information acquired prior to suspending. The apparatus may also include means for starting a system acquisition for a second GSM cell. The apparatus may further includes means for resuming the system acquisition of the first GSM cell using the stored information.

According to one aspect of the present disclosure, a computer program product for wireless communication in a wireless network includes a computer readable medium having non-transitory program code recorded thereon. The program code includes program code to start a system acquisition for a first Global System for Mobile Communications (GSM) cell. The program code may also include program code to suspend the system acquisition of the first GSM cell when a condition occurs. The program code may also include program code to store information acquired prior to suspending. The program code may further includes program code to start a system acquisition for a second GSM cell. The program code may further includes program code to resume the system acquisition of the first GSM cell using the stored information.

According to one aspect of the present disclosure, an apparatus for wireless communication includes a memory and a processor(s) coupled to the memory. The processor(s) is configured to start a system acquisition for a first Global System for Mobile Communications (GSM) cell. The processor(s) is also configured to suspend the system acquisition of the first GSM cell when a condition occurs. The processor(s) is also configured to store information acquired prior to suspending. The processor(s) is also configured to start a system acquisition for a second GSM cell. The processor(s) is further configured to resume the system acquisition of the first GSM cell using the stored information.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating the timing of channel carriers according to aspects of the present disclosure.

FIG. 6 is a process flow diagram illustrating a tone detection scheduling method according to one aspect of the present disclosure.

FIG. 7 is a diagram illustrating an example of a hardware implementation for an apparatus employing a tone detecting system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

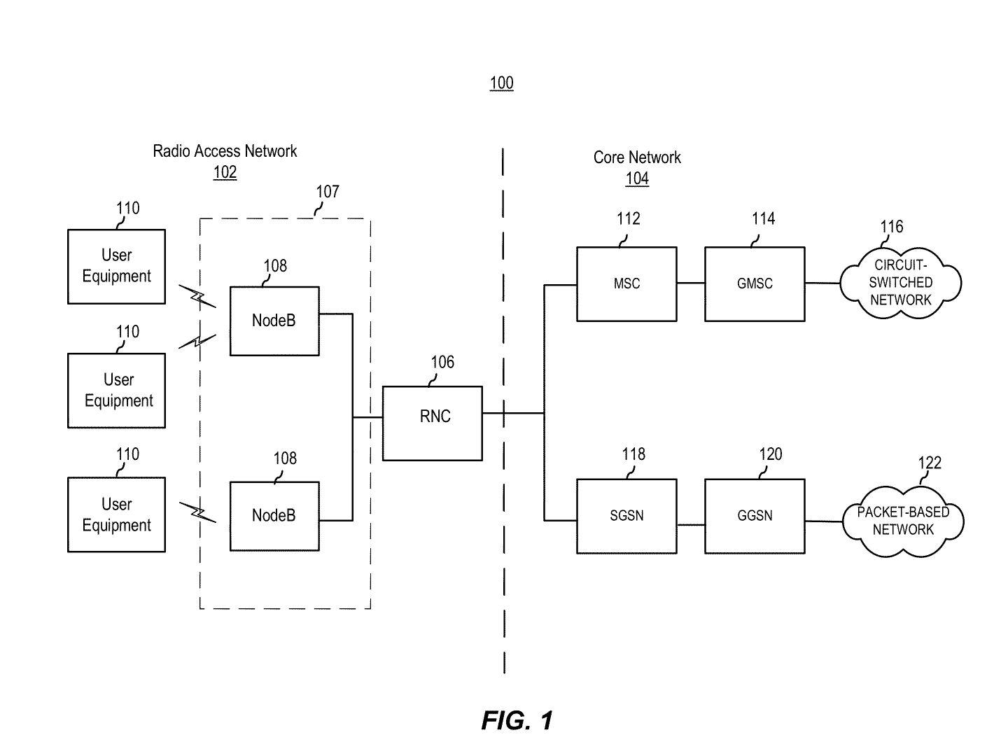

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

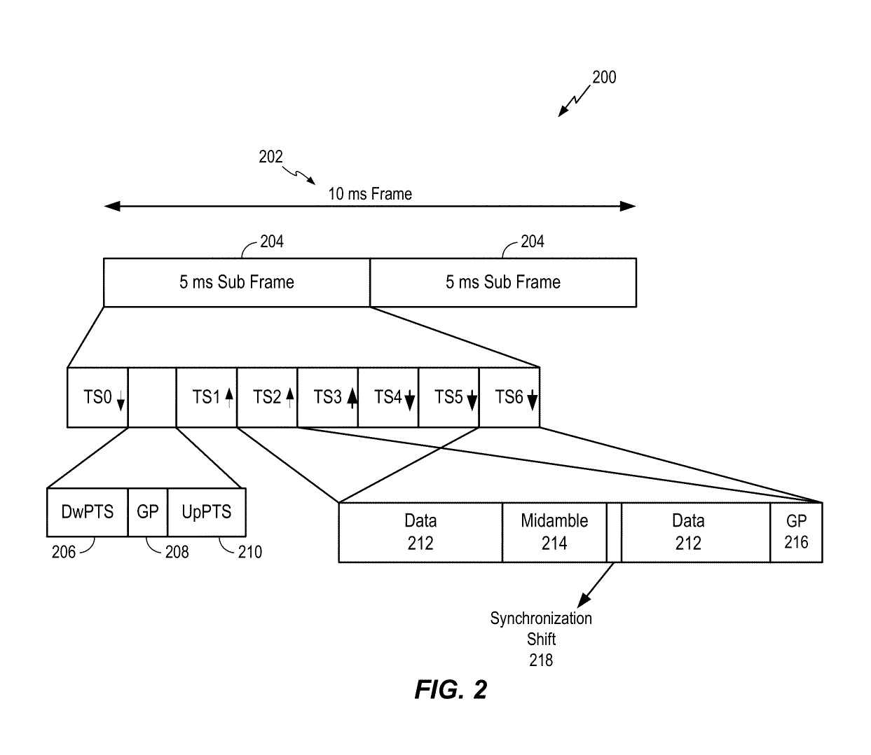

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS 1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

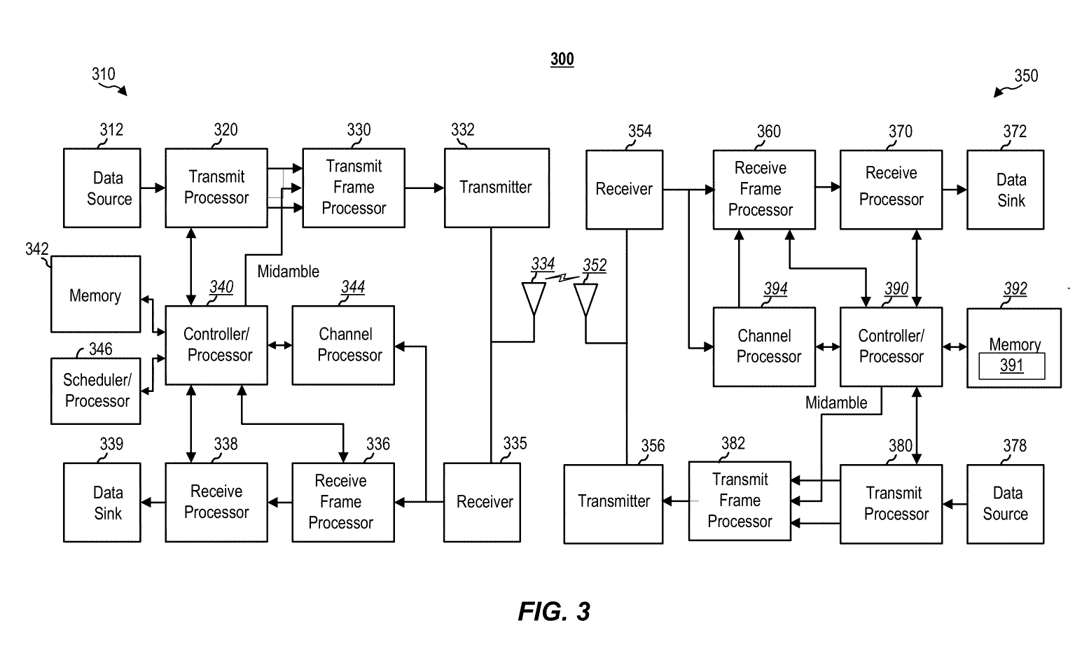

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store tone detection module 391 which, when executed by the controller/processor 390, configures the UE 350 to wait an adjustable period of time before aborting a system acquisition. A scheduler/processor 346 at the node B 310 may be used to allocate resources to the UEs and schedule downlink and/or uplink transmissions for the UEs.

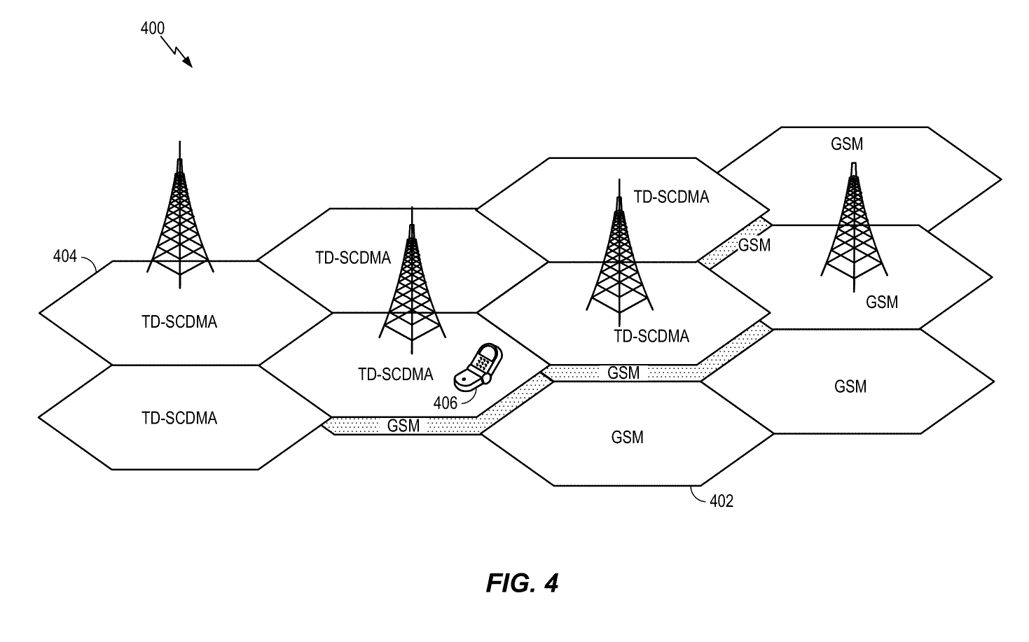

FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to detect if any WiFi networks exist in the vicinity of the UE. In one configuration, the UE may use TD-SCDMA reception/transmission gaps to switch to the WiFi network to scan the WiFi channels.

### Tone Detection Scheduling

Handover from a first radio access technology (RAT) to a second RAT may occur for several reasons. First, the network may prefer to have a user equipment (UE) primarily use the first RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

The BSIC of a cell in the second RAT is “verified” when the UE decodes the synchronization channel (SCH) of a broadcast control channel (BCCH) carrier, identifies the BSIC, at least one time, with an initial BSIC identification and reconfirms. The initial BSIC identification is performed within a predefined time period (for example, T_{identify}_{_{—}}_{abort}=5 seconds). The BSIC is re-confirmed at least once every T_{re-confirm}_{_{—}}_{abort} seconds (e.g., T_{re-confirmabort}=5 seconds). Otherwise, the BSIC of a cell in the second RAT is considered “non-verified.”

The UE maintains timing information of some neighbor cells, e.g., at least eight identified GSM cells in one configuration. The timing information may be useful for IRAT handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

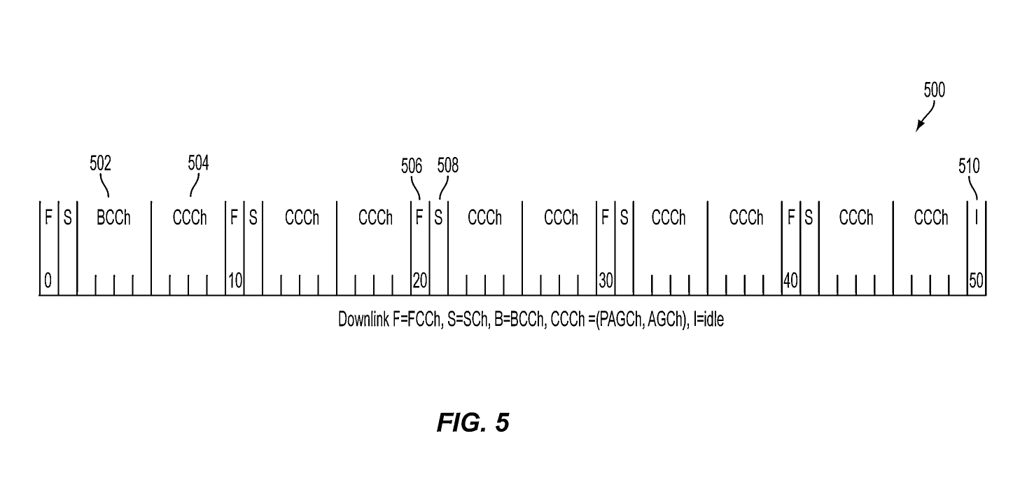

The initial BSIC identification procedure may take a longer amount of time to perform (e.g., up to 5 seconds or more) because there is no knowledge about the relative timing between the serving cell of the first RAT and the neighbor cells of the second RAT. This BSIC identification procedure may be part of a system acquisition of the neighbor cells. For example, the system acquisition may include a blind frequency correction channel (FCCH) burst or tone detection based on a fixed bit sequence carried on the FCCH to find the relative timing between the first RAT and the second RAT. The procedure may be considered fully blind due to a lack of knowledge about the relative timing between the first RAT and the second RAT. Exemplary timing of channel carriers are illustrated by the block diagram of FIG. 5

FIG. 5 is a block diagram 500 illustrating the timing of channels according to aspects of the present disclosure. The block diagram 500 shows a broadcast control channel (BCCH) 502, a common control channel (CCCH) 504, a frequency correction channel (FCCH) 506, a synchronization channel (SCH) 508 and an idle time slot 510. The numbers at the bottom of the block diagram 500 indicate various moments in time. In one configuration, the numbers at the bottom of the block diagram 500 are in seconds. In one configuration, each block of a FCCH 506 may include eight time slots, with only the first timeslot (or TS0) used for FCCH tone detection.

The timing of the channels shown in the block diagram 500 may be determined in a BSIC identification procedure. The BSIC identification procedure may include detection of the FCCH carrier 506, based on a fixed bit sequence that is carried on the FCCH 506. FCCH tone detection is performed to find the relative timing between multiple RATs. The FCCH tone detection may be based on the SCH 508 being either a first number of frames or a second number of frames later in time than the FCCH 506. The first number of frames may be equal to 11+n·10 frames and the second number of frames may be equal to 12+n·10 frames. The dot operator represents multiplication and n can be any positive number. These equations are used to schedule idle time slots to decode the SCH. The first number of frames and the second number of frames may be used to schedule idle time slots in order to decode the SCH 508, in case the SCH 508 falls into a measurement gap or an idle time slot 510.

For FCCH tone detection in an inter RAT measurement, the FCCH may fully or partially fall within the idle time slots of the first RAT (not shown). The UE attempts to detect FCCH tones (for example, such as the FCCH 506) on the BCCH carrier of the n strongest BCCH carriers of the cells in the second RAT. The strongest cells in the second RAT may be indicated by a measurement control message. In one configuration, n is eight and the n BCCH carriers are ranked in order of the signal strength. For example, a BCCH carrier may be ranked higher than other BCCH carriers when the signal strength of the BCCH carrier is stronger than the signal strength of the other BCCH carriers. The top ranked BCCH carrier may be prioritized for FCCH tone detection.

Each BCCH carrier may be associated with a neighbor cell in the second RAT. In some instances, the UE receives a neighbor cell list including n ranked neighbor cells from a base station of the first RAT, for example, in a measurement control message. The neighbor cells in the neighbor cell list may be ranked according to signal strength. In some configurations, the n ranked neighbor cells may correspond to the n strongest BCCH carriers, such that system acquisition of the neighbor cells includes FCCH tone detection of these BCCH carriers.

FCCH tone detection attempts are prioritized by the UE based on decreasing signal strength. The strongest BCCH carrier is defined as the BCCH carrier having the highest measured RSSI value after layer 3 (or network layer) filtering. The signal strength levels used in BSIC identification for arranging cells of the second RAT in decreasing signal strength order may be based on the latest carrier signal strength measurement results available for the second RAT. When the FCCH tone of a BCCH carrier of the second RAT is successfully detected, the UE immediately continues with the next BCCH carrier, in decreasing signal strength order. As a result, an unknown FCCH tone sometime in the future becomes the next detected FCCH tone.

In current implementations, the UE performs FCCH tone detection attempts for a next BCCH carrier in signal strength order only when the UE successfully detects an FCCH tone, or aborts the FCCH tone detection attempt after a fixed time duration. In one configuration, if the UE has not successfully detected the FCCH tone of the BCCH carrier within the fixed time (e.g., equal to 1.5 seconds), the UE aborts the FCCH tone detection attempt. The UE may then attempt to perform FCCH tone detection for the next BCCH carrier in signal strength order. Thus, tone detection is performed on a first frequency or first cell for a fixed amount of time before moving on to perform tone detection for the second frequency or second cell, the third frequency or third cell and so on. The BCCH carrier of the second RAT for which the FCCH tone detection attempts failed may be reconsidered after the FCCH tone detection attempts for the rest of the n strongest BCCH carriers of the second RAT.

In one configuration, the first RAT may be Time Division-Code Division Multiple Access (TD-SCDMA) and the second RAT may be Global System for Mobile Communications (GSM), Enhanced Data Rates for GSM Evolution (EDGE) or GSM EDGE Radio Access Network (GERAN).

During detection of an FCCH tone for the top ranked BCCH carrier, the signal strength of the top ranked BCCH carrier and/or the rest of the n BCCH carriers may change. For example, the signal strength of one or more of the n BCCH carriers may be increased or decreased due to mobility of the UE or changes in the radio frequency of the neighbor cells. The change in the signal strength of one or more of the n BCCH carriers may cause a change in the signal strength order of the n BCCH carriers. For example, the signal strength of the current top ranked BCCH carrier may be reduced below the signal strength of one or more of the other BCCH carriers. As a result, the signal strength order of the n BCCH carriers is changed.

In current implementations, the UE continues to attempt to detect FCCH tones for the current top ranked BCCH carrier, even though the signal strength of the current top ranked BCCH carrier is reduced below the signal strength of one or more of the other BCCH carriers. The UE stops attempting to detect FCCH tones for the current top ranked BCCH carrier only when the fixed time expires. Performing tone detection on the current top ranked BCCH carrier until the fixed time expires, results in a delay in FCCH tone detection for stronger BCCH carriers, which may result in IRAT handover failure.

Aspects of the present disclosure mitigate delays during system acquisition of neighbor cells, including FCCH tone detection of BCCH carriers, when an IRAT measurement condition changes. For example, a change in the IRAT measurement condition includes a change in the signal strength of one or more of the n BCCH carriers. The change in the IRAT measurement condition may cause an adjustment in the signal strength order of the n BCCH carriers. For example, a top ranked BCCH carrier may be replaced with a different BCCH carrier with a stronger signal strength.

In some aspects of the disclosure, during ongoing FCCH tone detection of the top ranked BCCH carrier, the FCCH tone detection may be suspended when an IRAT measurement conditions changes. For example, the FCCH tone detection of the top ranked BCCH carrier is suspended when the signal strength of the top ranked BCCH carrier falls below a signal strength of one or more other BCCH carriers.

In some aspects of the disclosure, the suspension of the FCCH tone detection of the top ranked BCCH carrier may be based on the change in the IRAT measurement condition and/or on a threshold operation. For example, the FCCH tone detection is suspended when the IRAT measurement condition changes and when the signal strength of the one or more BCCH carriers is above a network indicated threshold for sending a measurement report, and/or a UE internal predefined threshold. Further, the FCCH tone detection is suspended when the IRAT measurement condition changes and when a difference in signal strength between the top ranked BCCH carrier and another BCCH carrier is above a predefined threshold and maintained for a predefined time period. After the suspension, the UE may start FCCH tone detection for another BCCH carrier that is elevated to a top ranked status based on the signal strength. For example, the BCCH carrier with the strongest signal strength may be elevated to the top ranked status.

In some aspects of the disclosure, measurement information acquired prior to the suspension may be stored by the UE. The stored measurement information may include automatic gain control (AGC) information, coarse frequency information, coarse timing information, elapsed time and other system acquisition information. The UE may resume FCCH tone detection of the previous top ranked BCCH carrier using the stored measurement information. In this case, the FCCH tone detection for the previous top ranked BCCH carrier resumes from a time of the suspension, instead of starting a new FCCH tone detection. In one aspect of the disclosure, resuming the FCCH tone detection of the previous top ranked BCCH carrier may occur after successfully completing, suspending or aborting the FCCH detection of the elevated BCCH carrier.

Aspects of the present disclosure efficiently uses idle time slots for FCCH tone detection, thereby speeding up IRAT measurement procedures. The efficient use results in better IRAT handover performance as well.

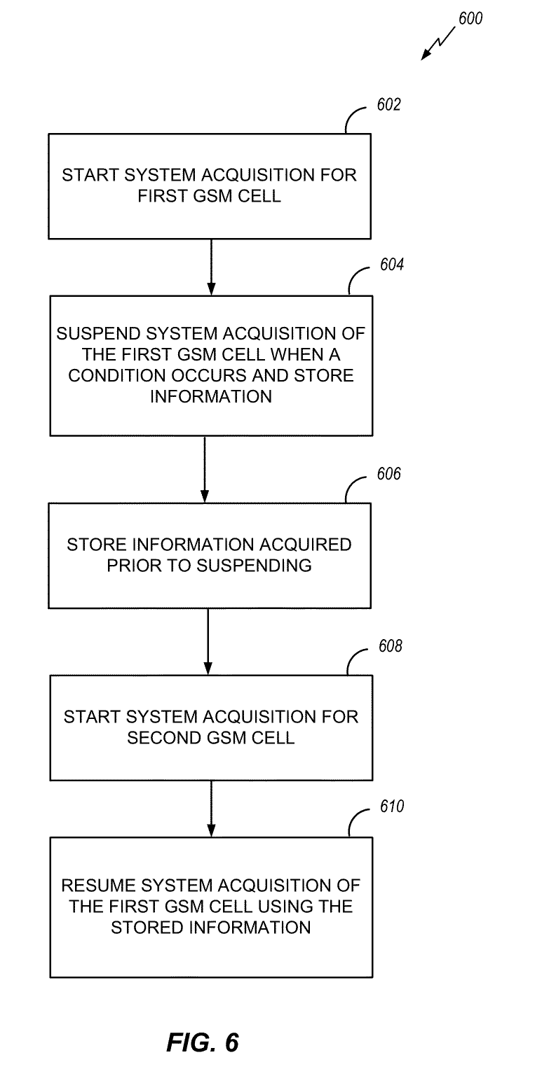

FIG. 6 illustrates a wireless communication method 600 according to one aspect of the present disclosure. A UE starts a system acquisition for a first Global System for Mobile Communications (GSM) cell, as shown in block 602. For example, the system acquisition for the first GSM cell may include FCCH tone detection for a BCCH carrier of the first GSM cell. The UE suspends the system acquisition of the first GSM cell when an IRAT measurement condition occurs, as shown in block 604. The UE then stores the information that had been acquired for the FCCH tone, prior to suspending, as shown in block 606. For example, a change in the IRAT measurement condition includes a change in the signal strength of one or more of the n BCCH carriers. As noted, the change in the IRAT measurement condition may cause a change in the signal strength order of the n BCCH carriers. The UE starts a system acquisition for a second GSM cell, as shown in block 608. After completing the attempt to acquire the second GSM cell, the UE resumes the system acquisition of the first GSM cell using the stored information, as shown in block 610.

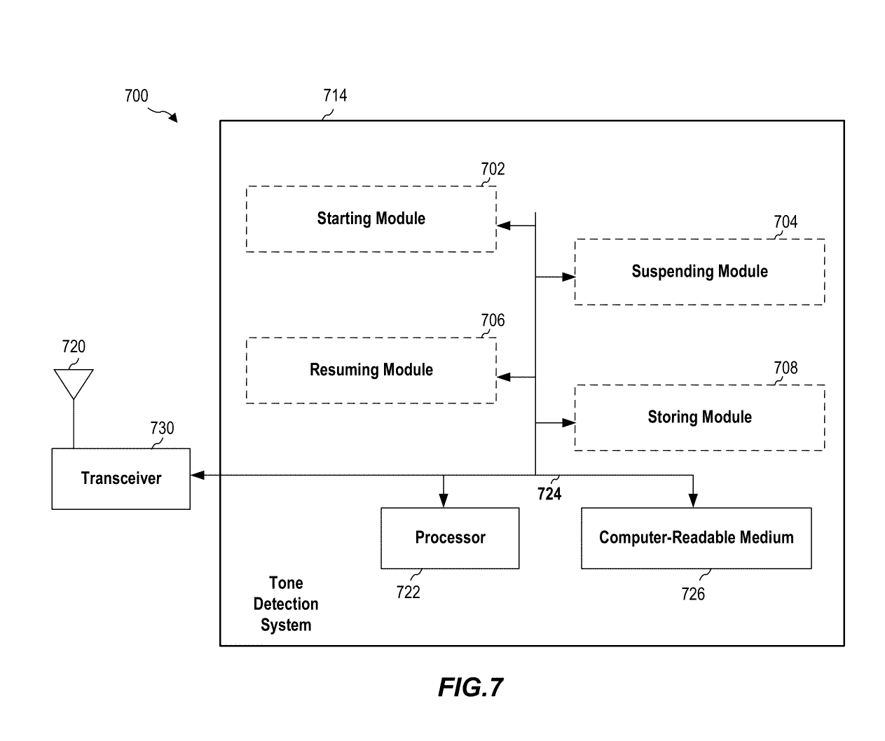

FIG. 7 is a diagram illustrating an example of a hardware implementation for an apparatus 700 employing a tone detection system 714. The tone detection system 714 may be implemented with a bus architecture, represented generally by the bus 724. The bus 724 may include any number of interconnecting buses and bridges depending on the specific application of the tone detection system 714 and the overall design constraints. The bus 724 links together various circuits including one or more processors and/or hardware modules, represented by the processor 722, a starting module 702, a suspending module 704, a storing module 708, a resuming module 706, and the computer-readable medium 726. The bus 724 may also link various other circuits such as timing sources, peripherals, voltage regulators, and power management circuits, which are well known in the art, and therefore, will not be described any further.

The apparatus includes a tone detection system 714 coupled to a transceiver 730. The transceiver 730 is coupled to one or more antennas 720. The transceiver 730 enables communicating with various other devices over a transmission medium. The tone detection system 714 includes a processor 722 coupled to a computer-readable medium 726. The processor 722 is responsible for general processing, including the execution of software stored on the computer-readable medium 726. The software, when executed by the processor 722, causes the tone detection system 714 to perform the various functions described for any particular apparatus. The computer-readable medium 726 may also be used for storing data that is manipulated by the processor 722 when executing software.

The tone detection system 714 includes a starting module 702 for starting a system acquisition for a first and second GSM cells. The tone detection system 714 also includes a suspending module 704 for suspending the system acquisition of the first GSM cell when a condition occurs. The tone detection system 714 also includes a storing module 708 for storing the information acquired during the suspended attempt. The tone detection system 714 also includes a resuming module 706 for resuming the system acquisition of the first GSM cell using the stored information. The modules may be software modules running in the processor 722, resident/stored in the computer-readable medium 726, one or more hardware modules coupled to the processor 722, or some combination thereof. The tone detection system 714 may be a component of the UE 350 and may include the memory 392, and/or the controller/processor 390.

In one configuration, an apparatus such as a UE is configured for wireless communication including means for starting. In one aspect, the above means may be the antenna 352/720, the transceiver 730, the receiver 354, the channel processor 394, the receive processor 370, the controller/processor 390, the memory 392, the tone detection module 391, the starting module 702, the processor 722, and/or the tone detection system 714 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for suspending. In one aspect, the above means may be the controller/processor 390, the memory 392, the tone detection module 391, the suspending module 704, the processor 722, and/or the tone detection system 714 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for storing. In one aspect, the above means may be the controller/processor 390, the memory 392, storing module 708, the computer readable medium 726, the processor 722, and/or the tone detection system 714 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for resuming. In one aspect, the above means may be the antenna 352/720, the transceiver 730, the receiver 354, the channel processor 394, the receive processor 370, the controller/processor 390, the memory 392, the tone detection module 391, the resuming module 706, the processor 722, and/or the tone detection system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
starting a system acquisition for a first Global System for Mobile Communications (GSM) cell,
suspending the system acquisition of the first GSM cell when a condition occurs;
storing information acquired prior to suspending;
starting a system acquisition for a second GSM cell; and
resuming the system acquisition of the first GSM cell using the stored information.

2. The method of claim 1, in which the resuming occurs after successfully completing, or failing and aborting the system acquisition of the second GSM cell.

3. The method of claim 1, in which the stored information comprises automatic gain control (AGC) information, coarse frequency information, coarse timing information, and/or elapsed time for acquisition of the first GSM cell.

4. The method of claim 1, in which the suspending occurs when a second cell signal strength is above a network indicated threshold for sending a measurement report, and/or a user equipment (UE) internal predefined threshold.

5. The method of claim 1, in which the suspending occurs when a difference in signal strength between the first GSM cell and the second GSM cell is above a predefined threshold and lasts for a predefined time period.

6. An apparatus for wireless communication, comprising:
means for starting a system acquisition for a first Global System for Mobile Communications (GSM) cell,
means for suspending the system acquisition of the first GSM cell when a condition occurs;
means for storing information acquired prior to suspending;
means for starting a system acquisition for a second GSM cell; and
means for resuming the system acquisition of the first GSM cell using the stored information.

7. The apparatus of claim 6, in which the resuming means resumes after successfully completing, or failing and aborting the system acquisition of the second GSM cell.

8. The apparatus of claim 6, in which the stored information comprises automatic gain control (AGC) information, coarse frequency information, coarse timing information, and/or elapsed time for acquisition of the first GSM cell.

9. The apparatus of claim 6, in which the means for suspending suspends when a second cell signal strength is above a network indicated threshold for sending a measurement report, and/or a user equipment (UE) internal predefined threshold.

10. The apparatus of claim 6, in which the means for suspending suspends when a difference in signal strength between the first GSM cell and the second GSM cell is above a predefined threshold and lasts for a predefined time period.

11. An apparatus for wireless communication, comprising:
a memory; and
at least one processor coupled to the memory and configured:
to start a system acquisition for a first Global System for Mobile Communications (GSM) cell,
to suspend the system acquisition of the first GSM cell when a condition occurs;
to store information acquired prior to suspending;
to start a system acquisition for a second GSM cell; and
to resume the system acquisition of the first GSM cell using the stored information.

12. The apparatus of claim 11, in which the at least one processor is further configured to resume the system acquisition of the first GSM cell after successfully completing, or failing and aborting the system acquisition of the second GSM cell.

13. The apparatus of claim 11, in which the stored information comprises automatic gain control (AGC) information, coarse frequency information, coarse timing information, and/or elapsed time for acquisition of the first GSM cell.

14. The apparatus of claim 11, in which the at least one processor is further configured to suspend the system acquisition of the first GSM cell when a second cell signal strength is above a network indicated threshold for sending a measurement report, and/or a user equipment (UE) internal predefined threshold.

15. The apparatus of claim 11, in which the at least one processor is further configured to suspend the system acquisition of the first GSM cell when a difference in signal strength between the first GSM cell and the second GSM cell is above a predefined threshold and lasts for a predefined time period.

16. A computer program product for wireless communications in a wireless network, comprising:
a non-transitory computer-readable medium having program code recorded thereon, the program code comprising:
program code to start a system acquisition for a first Global System for Mobile Communications (GSM) cell,
program code to suspend the system acquisition of the first GSM cell when a condition occurs;
program code to store information acquired prior to suspending;
program code to start a system acquisition for a second GSM cell; and
program code to resume the system acquisition of the first GSM cell using the stored information.

17. The computer program product of claim 16, in which the program code to resume further comprises program code to resume the system acquisition of the first GSM cell after successfully completing, or failing and aborting the system acquisition of the second GSM cell.

18. The computer program product of claim 16, in which the stored information comprises automatic gain control (AGC) information, coarse frequency information, coarse timing information, and/or elapsed time for acquisition of the first GSM cell.

19. The computer program product of claim 16, in which the program code to suspend further comprises program code to suspend the system acquisition of the first GSM cell when a second cell signal strength is above a network indicated threshold for sending a measurement report, and/or a user equipment (UE) internal predefined threshold.

20. The computer program product of claim 16, in which the program code to suspend further comprises program code to suspend the system acquisition of the first GSM cell when a difference in signal strength between the first GSM cell and the second GSM cell is above a predefined threshold and lasts for a predefined time period.
